(19) United States
(12) Patent Application Publication
(10) Pub. No.: US 2023/0152134 A1
(43) Pub. Date: May 18, 2023

(54) METHOD AND SYSTEM FOR PREDICTIVE FLOW MEASUREMENT AT IN-PLANT PIPING

(71) Applicant: SAUDI ARABIAN OIL COMPANY, Dhahran (SA)

(72) Inventors: Soelistiono Koesoemo Prasetiyo, Abqaiq (SA); Yazeed Menwer Almimouny, Abqaiq (SA); Moath Khalid Almansour, Abqaiq (SA)

(73) Assignee: SAUDI ARABIAN OIL COMPANY, Dhahran (SA)

(21) Appl. No.: 17/455,560

(22) Filed: Nov. 18, 2021

(51) Int. Cl. G01F 1/34; G01F 1/684; G01F 1/74; G05D 7/06; B01D 17/02; B01D 19/00; B01D 17/12; B01D 53/26; B01D 53/28; B01D 11/04

(52) U.S. Cl. CPC G01F 1/34; B01D 11/0492; B01D 17/12; B01D 17/0211; B01D 19/0042; B01D 19/0063; B01D 53/28; B01D 53/263; G01F 1/74; G01F 1/684; G05D 7/0623; G05B 15/02

(57) ABSTRACT

Upstream process equipment transmits a predetermined fluid to downstream process equipment. A valve fluidly couples the upstream process equipment to the downstream process equipment. A first pressure sensor and a first temperature sensor are coupled to the upstream process equipment and upstream from the valve. A second pressure sensor and a second temperature sensor are coupled to the downstream process equipment and downstream from the valve. A control system is coupled to the first pressure sensor, the first temperature sensor, the second pressure sensor, and the second temperature sensor. The control system determines a first fluid flowrate of the predetermined fluid using a fluid flow model based on pressure data from the first pressure sensor and the second pressure sensor, temperature data from the first temperature sensor and the second temperature sensor, a size of the valve, at least one fluid parameter regarding the predetermined fluid, and a valve flow coefficient of the valve.

### BACKGROUND

A flowmeter is a device/instrumentation that is used to measure flowrate of fluid passing through a piping circuit at a plant. The fluid type that can be measured can be a form of gas, liquid, or multiphase where both gas and liquid presence in the fluid. As illustrated by FIG. 1, a flowmeter 1 is installed within a pipe 2 of a piping circuit. The flowmeter 1 takes flowrate measurements of a fluid flow, see arrow 3, flowing through the pipe 2. Additionally, pressure sensors 4a, 4b positioned upstream and downstream the flowmeter 1 measure a pressure drop across the flowmeter 1. The flowmeter 1 installation requires a capital expense (CAPEX) which is a major expense for long term use. Thus, not all the pipes within the piping circuits are equipped with flowmeters. Some of the piping circuits cannot accommodate flowmeter installation because of congested area, inadequate pipe straight length, cost, and other factors. Additionally, the flowmeter 1 is required to be maintained such as preventive maintenance, obsolescence replacement program, inspections, and other non-productive time (NPT) operations. Therefore, conventional methods make it impractical to provide flowmeters at all piping circuits as the CAPEX will be greatly increased as well as increase the day-to-day operating expenses (OPEX).

The fluid flow, see arrow 3, in the pipe 2 can be characterized as one of three types which are laminar, transient, or turbulent flow. In laminar flow, the fluid travels as parallel layers (known as streamlines) that do not mix as they move in the direction of the flow (see arrow 3). In turbulent flow, the fluid does not travel in parallel layers, but moves in a haphazard manner with only the average motion of the fluid being parallel to an axis of the pipe 2. In transient flow, both types of laminar flow and turbulent flow may be present at different points along the pipe 2 or the flow may switch between the two. Typically, most of the fluid flow in the plant are in turbulent condition. As such, flowrate measurement plays a vital role in the piping circuit of the plant. However, conventional methods have poor accuracy along with the flowmeter 1 increasing the overall CAPEX and OPEX of the piping circuit.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system that may include upstream process equipment; downstream process equipment, the upstream process equipment may be configured to transmit a predetermined fluid to the downstream process equipment; a valve fluidly coupling the upstream process equipment to the downstream process equipment; a first pressure sensor and a first temperature sensor coupled to the upstream process equipment and disposed upstream from the valve; a second pressure sensor and a second temperature sensor coupled to the downstream process equipment and disposed downstream from the valve; and a control system coupled to the first pressure sensor, the first temperature sensor, the second pressure sensor, and the second temperature sensor. The control system determines a first fluid flowrate of the predetermined fluid using a fluid flow model based on pressure data from the first pressure sensor and the second pressure sensor, temperature data from the first temperature sensor and the second temperature sensor, a size of the valve, at least one fluid parameter regarding the predetermined fluid, and a valve flow coefficient of the valve.

In another aspect, embodiments disclosed herein relate to a method that may include obtaining, by a control system, first pressure data regarding a first pressure sensor upstream from a valve and second pressure data regarding a second pressure sensor downstream from the valve; obtaining, by the control system, temperature data regarding a first temperature sensor upstream from a valve and second temperature data regarding a second temperature sensor downstream from the valve; obtaining, by the control system, a fluid parameter regarding a predetermined fluid flowing through the valve and a plurality of valve parameters regarding the valve; and determining, by the control system, a first fluid flowrate of the predetermined fluid based on a fluid flow model using the first pressure data, the second pressure data, the first temperature data, the second temperature data, the fluid parameter, and the plurality of valve parameters.

In yet another aspect, embodiments disclosed herein relate to a system that may include a separator configured to transmit a gas stream to a dehydration unit, a water stream to an oily water system, and a condensate stream to a stripping column; a first valve configured to control flow between the separator and the dehydration unit; a second valve configured to control flow between the separator and the oily water system; a first pressure sensor and a first temperature sensor coupled to the separator; a second pressure sensor and a second temperature sensor coupled to the dehydration unit; a third pressure sensor and a third temperature sensor coupled to the oily water system; a first computer device coupled to the first pressure sensor, the first temperature sensor, the second pressure sensor, the second temperature sensor, and the first valve, the first computing device determines a first fluid flow rate of the gas stream using a first fluid flow model based on pressure data from the first pressure sensor and the second pressure sensor, temperature data from the first temperature sensor and the second temperature sensor, a size of the first valve, at least one fluid parameter regarding the gas stream, and a valve flow coefficient of the first valve; and a second computing device coupled to the first pressure sensor, the first temperature sensor, the third pressure sensor, the third temperature sensor, and the second valve, the second computing device determines a second fluid flow rate of the water stream using a second fluid flow model based on pressure data from the first pressure sensor and the third pressure sensor, temperature data from the first temperature sensor and the third temperature sensor, a size of the second valve, at least one fluid parameter regarding the water stream, and a valve flow coefficient of the second valve.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a schematic diagram of a flowmeter in accordance with prior art.

FIGS. 2 and 3 illustrate schematic depictions of a system for predictive flow measurements in a piping circuit in accordance with one or more embodiments of the present disclosure.

FIG. 4 illustrates a flowchart in accordance with one or more embodiments of the present disclosure.

FIG. 5 illustrates a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining a fluid flowrate within a piping circuit using virtual flow sensing. Rather than use a purely hardware flowmeter to determine fluid flowrates, soft measurement logic may be used to analyze a particular fluid flowrate. In some embodiments, for example, a virtual flow measurement system determines a fluid flowrate within process piping from existing instruments (e.g., pressure transmitters, temperature transmitters, valves, and control systems that are used for other plant purposes) and a fluid flow model for a specific fluid passing through the piping circuit. In particular, a control system (such as a distributed control system (DCS)) may implement this virtual flow sensing in some embodiments. The control system may obtain fluid property (i.e., fluid density or molecular weight), upstream pressure and temperature data, downstream pressure and temperature data, upstream and downstream piping geometry, a valve actual opening, a Valve Flow Coefficient (Cv), and valve characteristics (i.e., linear, or equal percentage, or quick opening), and then determine a fluid flowrate based on these parameters and other parameters associated with the fluid flow model.

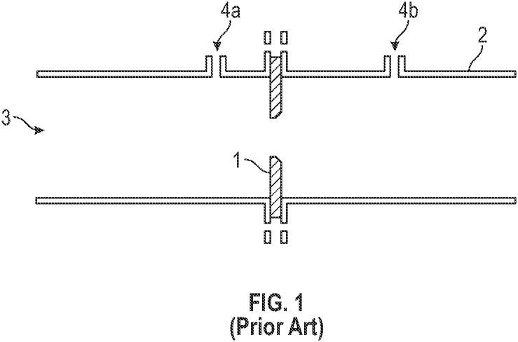

Furthermore, virtual flow sensing may be used in place of cumbersome physical flow measurement devices. By using available information from other measurements and process parameters, some embodiments may eliminate a need to install a hardware flowmeter to measure a particular fluid flowrate. For example, as illustrated in FIG. 1, the hardware flowmeter 1 may include differential pressure sensors 4a, 4b and corresponding orifice plates that may be approximated in virtual flow sensing using existing instruments. Thus, virtual flow sensing may avoid piping modifications to a plant as well as shutting down the facility, which can result in lost plant production.

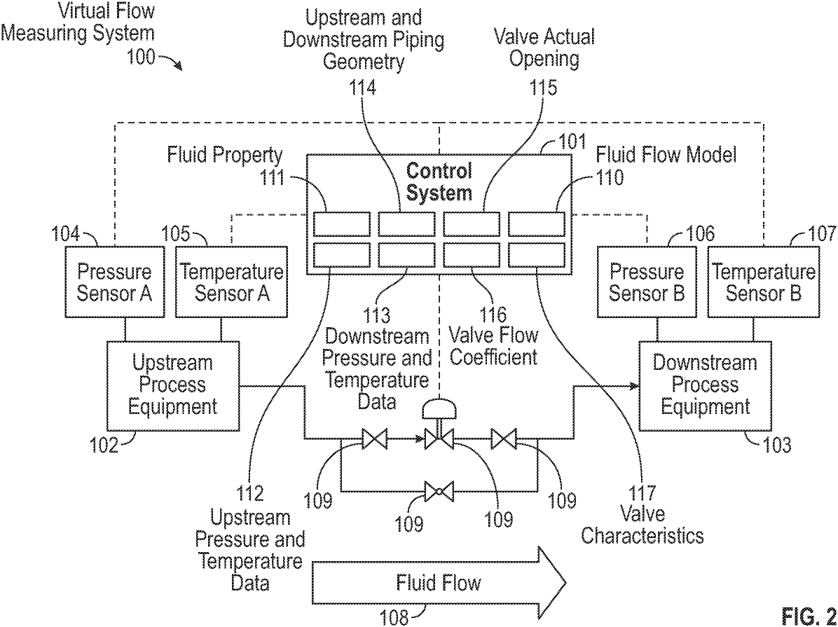

Turning to FIG. 2, FIG. 2 shows a schematic diagram in accordance with one or more embodiments. As shown in FIG. 2, a virtual flow measuring system 100 may include a control system 101, upstream process equipment 102, downstream process equipment 103, one or more valves 109, and various sensors (e.g., pressure sensor A 104, temperature sensor A 105, pressure sensor B 106, and temperature sensor B 107). As illustrated in FIG. 2, for example, the virtual flow measuring system 100 determines a rate of fluid flow 108 of a fluid exiting the upstream process equipment 102 that passes through the open valves 109 to the downstream process equipment 103. The one or more valves 109 may be a closure element with hardware for opening and closing a conduit connection, such as a gate valve, a shutoff valve, a ball valve, a control valve, etc.

Moreover, the virtual flow measuring system 100 may use various principles relating to a flowmeter to determine a fluid flowrate (108). With respect to flowmeters, flowmeters may include an orifice plate (also called a restriction plate) that define a hole for measuring a flowrate. The orifice plate may be a thin plate with an orifice’s hole, where the orifice plate is coupled to a pipeline. When a fluid (whether liquid or gaseous) passes through an orifice in the orifice plate, pressure may build upstream of the orifice. As fluid converges in order to pass through the orifice, fluid velocity may increase, which causes the fluid’s pressure to decrease. At a location downstream of the orifice, a flow may be the point of maximum convergence, where a fluid flowrate reaches a maximum value and the pressure approaches a minimum value. After this location, the fluid flow may expand resulting in the fluid flowrate to fall and pressure to increase. In comparison to FIG. 2, the pressure sensor A 104 may be an upstream pressure sensor to the open valves 109, while pressure sensor B 106 may be a downstream pressure sensor to the open valves 109. Additionally, the temperature sensor A 105 may be an upstream temperature sensor to the open valves 109, while the temperature sensor B 107 may be a downstream temperature sensor to the open valves 109.

In some embodiments, the control system 101 in the virtual flow measuring system 101 includes a fluid flow model 110. In particular, the fluid flow model 110 may describe one or more physical criteria or conditions for determining the fluid flowrate (108). For example, the fluid flow model 110 may specify various input parameters (e.g., fluid property 111, upstream pressure and temperature data 112, downstream pressure and temperature data 113, upstream and downstream piping geometry 114, a valve actual opening 115, a Valve Flow Coefficient (Cv) 116, and valve characteristics 117) to determine the fluid flowrate (108). For example, the fluid property 111 may include molecular weights, density values, expansion factors regarding the compressibility or incompressibility of a fluid flow, etc. The upstream pressure and temperature data 112 may include sensor values taken from the pressure sensor A 104 and the temperature sensor A 105. The downstream pressure and temperature data 113 may include sensor values taken from the pressure sensor B 106 and the temperature sensor B 107. The upstream and downstream piping geometry 114 may include one or more physical pipe dimensions, such as an inside diameter of one or more pipes or a length of pipe, for example. The valve actual opening 115 may describe a particular restricted valve, such as a diameter ratio of a restricted valve, a discharge coefficient that may describe the ratio of an actual discharge through the open valves 109 in relation to the theoretical discharge, an expansion factor, etc. The Cv 116 is a capacity of the open valves 109 to deliver flow with an available differential pressure (ΔP) across the open valves 109. The valve characteristics 117 may include the type of the valve (109) being used.

In some embodiments, for example, the fluid flow model 110 corresponds to an orifice flow model for determining the fluid flowrate (108) that is expressed using the following equations:
Density of a Gas:
$$\text{ρ} = \left(\text{PM}\right) \text{} \text{/} \text{} \left(\text{zRT}\right)$$
where:
   ρ is a gas density;
   P is actual gas pressure;
   M is molar mass;
   z is gas compressibility factor;
   R is gas constant; and
   T is actual gas temperature.
Specific gravity of a Gas or Liquid:
$$\text{SG} = \text{ρ} / {\text{ρ}}_{\text{ref}}$$
where:
   SG is specific gravity of gas or liquid;
   ρ is density of fluid calculated in Equation 1; and
   ρ_{ref} is referenced density.
Upstream and downstream line pressure loss calculation:
$$\begin{matrix}\text{Δ} \text{p} = \text{f} \left(\text{L/D}\right) \left(\text{ρ} {\text{/g}}_{\text{c}}\right) \\ \left({\text{v}}^{2} \text{/} 2\right)\end{matrix}$$
where:
   Δp is line pressure drop;
   F is friction factor;
   L is length of pipe;
   D is pipe internal diameter;
   ρ is fluid density at mean temperature;
   v is fluid velocity; and
   g_{c} is unit conversion factor (3.2 ft.lbₘ/lb.s²).
Pressure losses through bends, tees, reducer, isolation valves, and other components of the piping circuit:
$$Δ \text{p = K} \text{ρ} {\text{v}}^{2} \text{/} 2$$
where:
   Δp is piping element pressure drop;
   K is piping element constant;
   ρ is fluid density at mean temperature; and
   v is fluid velocity.
Pressure drop across the valve:
$$Δ \text{P} = {\text{P}}_{1} - \left(Δ {\text{p}}_{1} + Δ {\text{p}}_{2} + {\text{P}}_{2}\right)$$
where:
   ΔP is pressure drop across the valve;
   P1 is upstream equipment pressure;
   P2 is downstream equipment pressure;
   Δp₁ is upstream valve piping pressure drop; and
   Δp₂ is downstream valve piping pressure drop.
Valve Cv is predetermined and put into a calculation block based on the actual valve characteristic where the valve Cv for every valve opening is plotted and used for the flowrate calculation in Equation 6 below. The valve Cv is specific for each valve.
Knowing the fluid specific gravity, line pressure losses, and valve Cv from Equations 1-5, the fluid flowrate (108) is calculated as:
$$\text{Q} = \text{Cv} \left(\text{SQRT} \left(Δ \text{P/SG}\right)\right)$$
where:
   Cv is valve coefficient;
   Q is fluid flowrate;
   ΔP is pressure drop across the valve; and
   SG is fluid specific gravity.

Equation 1 applies to gas line while equation 2 to 6 applies to either gas or liquid lines.

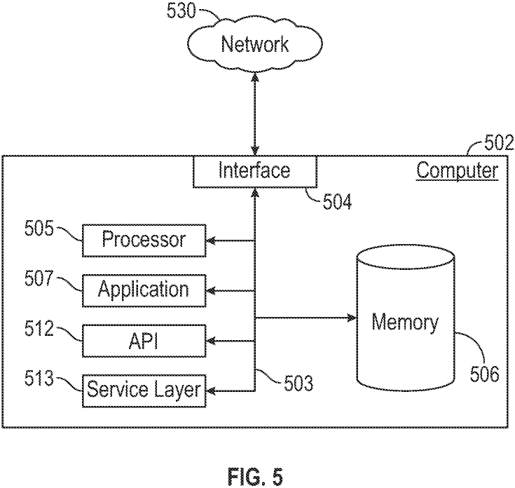

With respect to the control system 101, the control system 101 may include hardware and/or software that monitors and/or operates equipment, such as at a plant. In particular, the control system 101 may be coupled to facility equipment (102, 103) and sensors (104-107) to collect data throughout a facility. For example, facility equipment may include various hardware components, such as heat exchangers, pumps, valves, compressors, production traps, knockout vessels, desalters, loading racks, and storage tanks among various other types of hardware components. Examples of sensors may include pressure sensors, temperature sensors, torque sensors, rotary switches, weight sensors, position sensors, microswitches, hydrophones, accelerometers, etc. In some embodiments, the control system 101 may include a programmable logic controller that may control valve states, fluid levels, pipe pressures, warning alarms, pressure releases and/or various hardware components throughout a facility. Thus, a programmable logic controller may be a ruggedized computer system with functionality to withstand vibrations, extreme temperatures, wet conditions, and/or dusty conditions, such as those around a refinery or drilling rig. Furthermore, a control system may be a computer system similar to the computer system (502) described in FIG. 5 and the accompanying description.

In some embodiments, the control system 101 includes a distributed control system (DCS). A distributed control system may be a computer system for managing various processes at a facility using multiple control loops. As such, a distributed control system may include various autonomous controllers (such as remote terminal units) positioned at different locations throughout the facility to manage operations and monitor processes. Likewise, a distributed control system may include no single centralized computer for managing control loops and other operations. On the other hand, a SCADA system may include a control system that includes functionality for enabling monitoring and issuing of process commands through local control at a facility as well as remote control outside the facility. With respect to an RTU, an RTU may include hardware and/or software, such as a microprocessor, that connects sensors and/or actuators using network connections to perform various processes in the automation system.

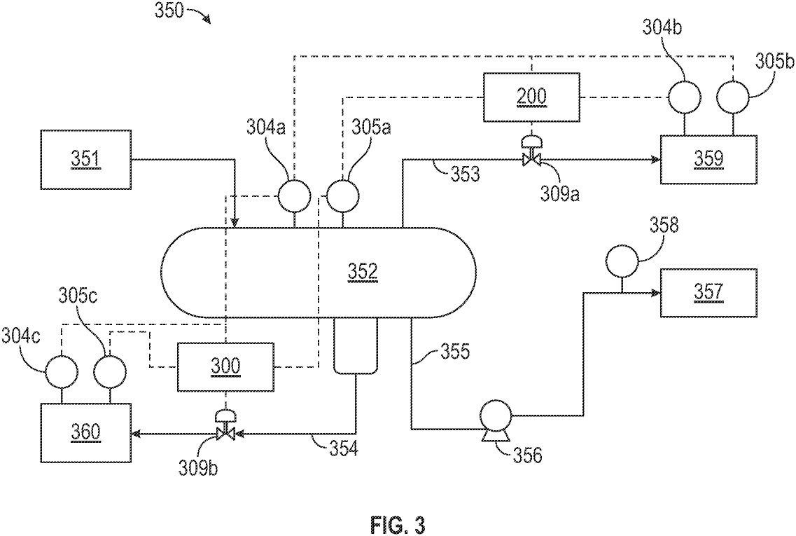

Turning to FIG. 3, FIG. 3 shows a schematic diagram in accordance with one or more embodiments. As shown in FIG. 3, FIG. 3 illustrates a piping circuit 350 that includes an upstream processing unit 351 that injects fluids into a stripper feed separator 351. The stripper feed separator 352 separates the fluids from the upstream processing unit 351 into gas components and liquid components, such as a gas stream 353, a water stream 354, and a condensate stream 355 (e.g., hydrocarbon liquids). For example, the stripper feed separator 352 may be a three-phase separator that includes various hardware components, such as a deflector, a water retention baffle, various compartments, etc. The fluids from the upstream processing unit 351 may be a wet crude oil that enters the stripper feed separator 352, the wet crude oil may separate into various outputs, e.g., off-gas (the gas stream 353), processed wet crude oil (the condensate stream 355 such as a wet crude oil output that may still include some water and gas), and oily water (the water stream 354 such as an oily water output that may include produced water with some remaining crude oil).

The condensate stream 355 may include a pump 356 to pump the hydrocarbon liquids to a stripping column 357. The stripping column 357 may be used to strip, with air or steam, total reduced sulfur and other hazardous compounds from the condensate stream 355. Additionally, an orifice flowmeter 358 is only provided on the condensate stream 355 as part of original system design of the piping circuit 350.

The gas stream 353 includes a first valve 309a to control a flow of fluids from the stripper feed separator 352 to a dehydration unit 359. The dehydration unit 359 removes water vapor from the gas stream 353 to prevent hydrate formation. For example, a wet gas of the gas stream 353 contacts dry glycol within the dehydration unit 359, and the glycol absorbs water from the gas stream 353. Further, the first valve 309a may be a closure element with hardware for opening and closing a conduit connection of the gas stream 353, such as a gate valve, a shutoff valve, a ball valve, a control valve, etc.

The water stream 354 includes a second valve 309b to control a flow of fluids from the stripper feed separator 352 to an oily water system 360 (e.g., water treatment tank). The oily water system 360 may include a treatment system to treat the water stream 354 and reduce pollutants to acceptable levels for wastewater. Additionally, through various water treatments, the water stream 354 may be reused. Further, the second valve 309b may be a closure element with hardware for opening and closing a conduit connection of the water stream 354, such as a gate valve, a shutoff valve, a ball valve, a control valve, etc.

Still referring to FIG. 3, a plurality of sensors (304a-305c) is provided on the various components of the piping circuit 350. For example, a first pressure 304a is provided on the stripper feed separator 352, a second pressure 304b is provided on the dehydration unit 359, and a third pressure 304c is provided on the oily water system 360. Additionally, a first temperature 305a is provided on the stripper feed separator 352, a second temperature 305b is provided on the dehydration unit 359, and a third temperature 305c is provided on the oily water system 360.

In one or more embodiments, the piping circuit 350 may include one or more virtual flow measuring systems (e.g., a first virtual flow measuring system 200 and a second virtual flow measuring system 300) that include functionality for determining one or more fluid flowrates. The first virtual flow measuring system 200 and the second virtual flow measuring system 300 are coupled to the gas stream 353 and the water stream 354, respectively. The first virtual flow measuring system 200 and the second virtual flow measuring system 300 are similar to the virtual flow measuring system 100 as described in FIG. 2 and use Equations 1-7 for determining one or more fluid flowrates. For example, the first virtual flow measuring system 200 is in communication with the first valve 309a, the first pressure 304a, the second pressure 304b, the first temperature 305a, and the second temperature 305b. The second virtual flow measuring system 300 is in communication with the second valve 309b, the first pressure 304a, the third pressure 304c, the first temperature 305a, and the third temperature 305c.

The first virtual flow measuring system 200 and the second virtual flow measuring system 300 provide constant monitoring of the gas stream 353 and the water stream 354. By having the first virtual flow measuring system 200 and the second virtual flow measuring system 300, the gas stream 353 and the water stream 354 do not need flowmeters which require piping modification, instrumentation and cables, and unit shutdown which can be expensive.

In some embodiments, during operation of the piping circuit 350, the first virtual flow measuring system 200 and the second virtual flow measuring system 300 collects and records data from the plurality of sensors (304a-305c). The data includes, for example, a record of measurements of upstream pressure (e.g., pressure at the stripper feed separator 352), upstream temperature (e.g., temperature at the stripper feed separator 352), downstream pressure (e.g., pressure at the dehydration unit 359 and the oily water system 360), and the downstream temperature (e.g., pressure at the dehydration unit 359 and the oily water system 360). In some embodiments, the measurements are recorded in real-time, and are available for review or use within seconds, minutes or hours of the condition being sensed (e.g., the measurements are available within 1 hour of the condition being sensed). In such an embodiment, the data may be referred to as “real-time” data. Real-time data may enable an operator of the piping circuit 350 to assess a relatively current state of the fluids within the stripper feed separator 352 and make real-time decisions regarding fluid flow within the piping circuit 350.

In some embodiments, the first virtual flow measuring system 200 and the second virtual flow measuring system 300 may include a control system or other computer device that acquires sensor measurements from the plurality of sensors (304a-305c) with respect to a predetermined plant environment. Based on knowledge of this plant environment, a virtual flow measuring system may determine the fluid flowrate at a particular location in the piping circuit 350 without using a flowmeter. In some embodiments, for example, a virtual flow measuring system uses a fluid flow model to determine a respective flow rate.

While FIGS. 2 and 3 shows various configurations of components, other configurations may be used without departing from the scope of the disclosure. For example, various components in FIGS. 2 and 3 may be combined to create a single component. As another example, the functionality performed by a single component may be performed by two or more components.

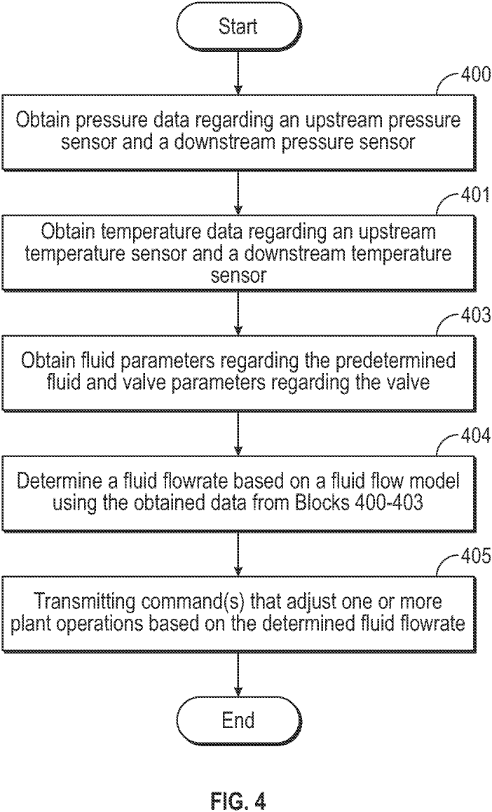

Turning to FIG. 4, FIG. 4 shows a flowchart in accordance with one or more embodiments. Specifically, FIG. 4 describes a general method for virtual flow sensing. One or more blocks in FIG. 4 may be performed by one or more components (e.g., virtual flow measuring system 100, 200, 300) as described in FIGS. 2 and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, pressure data are obtained regarding an upstream pressure sensor and a downstream pressure sensor in accordance with one or more embodiments. For example, fluid flow may pass through a particular valve, where upstream and downstream may be determined with respect to the particular valve. The particular valve may refer to a particular section of processing pipe with a valve with constant physical dimensions that are proximate upstream and downstream pressure sensors.

In Block 401, temperature data are obtained regarding an upstream temperature sensor and a downstream temperature sensor in accordance with one or more embodiments. For example, as the fluid flow passes through the particular valve, upstream and downstream temperature sensors proximate the particular valve are used to record and transmit the temperature data. It is further envisioned that the temperature data may also include predicted temperature data extrapolated/interpolated for a particular valve based on other temperature sensor measurements.

In Block 403, various fluid parameters regarding a predetermined fluid and various valve parameters regarding a particular valve are obtained in accordance with one or more embodiments. In some embodiments, for example, parameters are manually input by a user, such as using a user device (e.g., a human machine interface). For example, the input information may relate to various physical properties for a particular valve (e.g., size, the Cv of the valve, valve characteristic, etc.) and fluid parameters (e.g., molecular weight, density, etc.). Likewise, information may be selected by a user within a graphical user interface and communicated to a computer device over a network. In some embodiments, fluid parameters are stored in association with a valve type (e.g., corresponding to a particular type of pipe) or a predetermined fluid type, such as in a database or table. Thus, once a fluid type or valve type is selected by a user or a control system, fluid parameters may be determined accordingly. In some embodiments, a sensor may be used to determine a type of predetermined fluid, which may be subsequently used to determine the corresponding fluid parameters. Where the fluid or valve changes, the fluids parameters and valve parameters may be updated accordingly. For example, a fluid flow correlation may rely on specific fluid properties and/or specific valve parameters. Therefore, changes in fluid properties may affect the accuracy of a particular fluid flow rate measurement.

In Block 404, a fluid flowrate of a predetermined fluid is determined based on a gas flow model, pressure data, temperature data, various fluid parameters, and various valve parameters from Blocks 400-403 in accordance with one or more embodiments. In particular, various systematic rules may be applied to pressure data and/or temperature to determine one or more fluid flowrates. For example, the fluid flow model may correspond to Equation 1 described above with respect to a valve flow. In some embodiments, the fluid flow model may be an algorithmic black box, such as a trained artificial neural network, where an output fluid flow rate is based on input values corresponding to various parameters.

In Block 405, one or more commands are transmitted that adjust one or more plant operations based on the determined fluid flowrate in accordance with one or more embodiments. In some embodiments, the fluid flowrate is used in one or more applications within a plant. As such, a control system may adjust settings on one or more plant devices to achieve an optimal fluid flow, e.g., valve sequences or fluid separating operations. In some embodiments, fluid flowrates are modified to achieve specific environmental impacts, such as reduce pollution. Likewise, other streams in a plant may be adjusted with respect to a particular fluid flowrate value, e.g., a production stream may be increased or decreased according to a desired fluid flowrate at one outlet.

The present disclosure is seen has having straightforward internal deployment potential and provides value through a cost effective, maintenance non-intensive flow measurement relative to the conventional flowmeter that are maintenance intensives and having high installation costs. The disclosure utilizes the existing in-plant process indicator, piping geometry, fluid properties, and valve characteristic to predict fluid flowrate inside the piping circuit.

Embodiments may be implemented on a computing device. FIG. 5 is a block diagram of a computing device, such as a computer system 502 used to provide computational functionalities associated with described algorithms, methods, functions, processes, flows, and procedures as described in the instant disclosure, according to an implementation. The illustrated computer 502 is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 502 may include a computer that includes an input device, such as a keypad, keyboard, touch screen, or other device that can accept user information, and an output device that conveys information associated with the operation of the computer 502, including digital data, visual, or audio information (or a combination of information), or a GUI.

The computer 502 can serve in a role as a client, network component, a server, a database or other persistency, or any other component (or a combination of roles) of a computer system for performing the subject matter described in the instant disclosure. The illustrated computer 502 is communicably coupled with a network 530. In some implementations, one or more components of the computer 502 may be configured to operate within environments, including cloud-computing-based, local, global, or other environment (or a combination of environments).

At a high level, the computer 502 is an electronic computing device operable to receive, transmit, process, store, or manage data and information associated with the described subject matter. According to some implementations, the computer 502 may also include or be communicably coupled with an application server, e-mail server, web server, caching server, streaming data server, business intelligence (BI) server, or other server (or a combination of servers).

The computer 502 can receive requests over network 530 from a client application (for example, executing on another computer 502) and responding to the received requests by processing the said requests in an appropriate software application. In addition, requests may also be sent to the computer 502 from internal users (for example, from a command console or by other appropriate access method), external or third-parties, other automated applications, as well as any other appropriate entities, individuals, systems, or computers.

Each of the components of the computer 502 can communicate using a system bus 503. In some implementations, any or all of the components of the computer 502, both hardware or software (or a combination of hardware and software), may interface with each other or the interface 504 (or a combination of both) over the system bus 503 using an application programming interface (API) 512 or a service layer 513 (or a combination of the API 512 and service layer 513. The API 512 may include specifications for routines, data structures, and object classes. The API 512 may be either computer-language independent or dependent and refer to a complete interface, a single function, or even a set of APIs. The service layer 513 provides software services to the computer 502 or other components (whether or not illustrated) that are communicably coupled to the computer 502. The functionality of the computer 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or another suitable format. While illustrated as an integrated component of the computer 502, alternative implementations may illustrate the API 512 or the service layer 513 as stand-alone components in relation to other components of the computer 502 or other components (whether or not illustrated) that are communicably coupled to the computer 502. Moreover, any or all parts of the API 512 or the service layer 513 may be implemented as child or sub-modules of another software module, enterprise application, or hardware module without departing from the scope of this disclosure.

The computer 502 includes an interface 504. Although illustrated as a single interface 504 in FIG. 5, two or more interfaces 504 may be used according to particular needs, desires, or particular implementations of the computer 502. The interface 504 is used by the computer 502 for communicating with other systems in a distributed environment that are connected to the network 530. Generally, the interface 504 includes logic encoded in software or hardware (or a combination of software and hardware) and operable to communicate with the network 530. More specifically, the interface 504 may include software supporting one or more communication protocols associated with communications such that the network 530 or interface’s hardware is operable to communicate physical signals within and outside of the illustrated computer 502.

The computer 502 includes at least one computer processor 505. Although illustrated as a single computer processor 505 in FIG. 5, two or more processors may be used according to particular needs, desires, or particular implementations of the computer 502. Generally, the computer processor 505 executes instructions and manipulates data to perform the operations of the computer 502 and any algorithms, methods, functions, processes, flows, and procedures as described in the instant disclosure.

The computer 502 also includes a memory 506 that holds data for the computer 502 or other components (or a combination of both) that can be connected to the network 530. For example, memory 506 can be a database storing data consistent with this disclosure. Although illustrated as a single memory 506 in FIG. 5, two or more memories may be used according to particular needs, desires, or particular implementations of the computer 502 and the described functionality. While memory 506 is illustrated as an integral component of the computer 502, in alternative implementations, memory 506 can be external to the computer 502.

The application 507 is an algorithmic software engine providing functionality according to particular needs, desires, or particular implementations of the computer 502, particularly with respect to functionality described in this disclosure. For example, application 507 can serve as one or more components, modules, applications, etc. Further, although illustrated as a single application 507, the application 507 may be implemented as multiple applications 507 on the computer 502. In addition, although illustrated as integral to the computer 502, in alternative implementations, the application 507 can be external to the computer 502.

There may be any number of computers 502 associated with, or external to, a computer system containing computer 502, each computer 502 communicating over network 530. Further, the term “client,” “user,” and other appropriate terminology may be used interchangeably as appropriate without departing from the scope of this disclosure. Moreover, this disclosure contemplates that many users may use one computer 502, or that one user may use multiple computers 502.

In some embodiments, the computer 502 is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

In addition to the benefits described above, the virtual flow measuring system may improve an overall efficiency and performance at the plant while reducing cost and risk of non-productive time (NPT), and many other advantages. Further, the virtual flow measuring system may provide further advantages such as being able to decrease maintenance and operating cost, to be used in piping locations that a flowmeter cannot be installed and is not limited to any type of fluid (e.g., hydrocarbon, water, steam, nitrogen, and other fluids in either vapor or liquid phase).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A system, comprising:
upstream process equipment;
downstream process equipment, wherein the upstream process equipment is configured to transmit a predetermined fluid to the downstream process equipment;
a valve fluidly coupling the upstream process equipment to the downstream process equipment;
a first pressure sensor and a first temperature sensor coupled to the upstream process equipment and disposed upstream from the valve;
a second pressure sensor and a second temperature sensor coupled to the downstream process equipment and disposed downstream from the valve; and
a control system coupled to the first pressure sensor, the first temperature sensor, the second pressure sensor, and the second temperature sensor,
wherein the control system determines a first fluid flowrate of the predetermined fluid using a fluid flow model based on pressure data from the first pressure sensor and the second pressure sensor, temperature data from the first temperature sensor and the second temperature sensor, a size of the valve, at least one fluid parameter regarding the predetermined fluid, and a valve flow coefficient of the valve.

2. The system of claim 1,
wherein the fluid flow model is based on a fluid flow equation, and
wherein the at least one fluid parameter corresponds to a fluid density or a molecular weight of the predetermined fluid.

3. The system of claim 1, wherein the upstream process equipment is a separator of a piping circuit.

4. The system of claim 3, wherein the downstream process equipment is a dehydration unit or an oily water system.

5. The system of claim 4, further comprising:
a stripping column downstream of the separator; and
a flowmeter provided between the stripping column and the upstream process equipment.

6. The system of claim 5,
wherein a gas stream, a water stream, and a condensate stream from the separator is transmitted to the dehydration unit, the oily water system, and the stripping column,
wherein the predetermined fluid is obtained from the gas stream or the water stream.

7. The system of claim 3, wherein the control system adjusts the first fluid flow rate to produce a second fluid flow rate of the predetermined fluid that maintains a production from the separator.

8. The system of claim 1, further comprising:
a virtual measuring device provide on the control system.

9. The system of claim 6,
wherein the control system is a distributed control system (DCS).

10. A method, comprising:
obtaining, by a control system, first pressure data regarding a first pressure sensor upstream from a valve and second pressure data regarding a second pressure sensor downstream from the valve;
obtaining, by the control system, temperature data regarding a first temperature sensor upstream from a valve and second temperature data regarding a second temperature sensor downstream from the valve;
obtaining, by the control system, a fluid parameter regarding a predetermined fluid flowing through the valve and a plurality of valve parameters regarding the valve; and
determining, by the control system, a first fluid flowrate of the predetermined fluid based on a fluid flow model using the first pressure data, the second pressure data, the first temperature data, the second temperature data, the fluid parameter, and the plurality of valve parameters.

11. The method of claim 10, further comprising:
transmitting, by the control system, a command that adjusts the first fluid flow rate to produce a second fluid flow rate of the predetermined fluid.

12. The method of claim 10, further comprising:
obtaining, by the control system, temperature data regarding a temperature sensor coupled to the restricted orifice,
wherein the temperature data describes a difference between an ambient temperature and a flow temperature at the restricted orifice, and
wherein the first gas flow rate is determined based on the temperature data.

13. The method of claim 10, wherein the plurality of valve parameters comprises a size of the valve and a valve flow coefficient of the valve, and wherein the fluid parameter is a fluid density or a molecular weight.

14. The method of claim 10,
wherein the control system determines a plurality of flow flowrates for a plurality of restricted valves in a piping circuit, and
wherein the control system is a distributed control system (DCS).

15. A system, comprising:
a separator configured to transmit a gas stream to a dehydration unit, a water stream to an oily water system, and a condensate stream to a stripping column;
a first valve configured to control flow between the separator and the dehydration unit;
a second valve configured to control flow between the separator and the oily water system;
a first pressure sensor and a first temperature sensor coupled to the separator;
a second pressure sensor and a second temperature sensor coupled to the dehydration unit;
a third pressure sensor and a third temperature sensor coupled to the oily water system;
a first computer device coupled to the first pressure sensor, the first temperature sensor, the second pressure sensor, the second temperature sensor, and the first valve,
wherein the first computing device determines a first fluid flow rate of the gas stream using a first fluid flow model based on pressure data from the first pressure sensor and the second pressure sensor, temperature data from the first temperature sensor and the second temperature sensor, a size of the first valve, at least one fluid parameter regarding the gas stream, and a valve flow coefficient of the first valve; and
a second computing device coupled to the first pressure sensor, the first temperature sensor, the third pressure sensor, the third temperature sensor, and the second valve,
wherein the second computing device determines a second fluid flow rate of the water stream using a second fluid flow model based on pressure data from the first pressure sensor and the third pressure sensor, temperature data from the first temperature sensor and the third temperature sensor, a size of the second valve, at least one fluid parameter regarding the water stream, and a valve flow coefficient of the second valve.

16. The system of claim 15, further comprising: a pump configured to pump the condensate stream from the separator to a stripping column.

17. The system of claim 15, further comprising: an orifice flowmeter provided on the condensate stream between the pump and the stripping column.
